(19) United States
(12) Patent Application Publication
(10) Pub. No.: US 2011/0109502 A1
(43) Pub. Date: May 12, 2011

(54) APPARATUS, SYSTEM AND METHOD FOR DISPLAYING CONSTRUCTION-RELATED DOCUMENTS

(76) Inventor: Steven J. Sullivan, Palm City, FL (US)

(21) Appl. No.: 12/780,021

(22) Filed: May 14, 2010

Related U.S. Application Data
(60) Provisional application No. 61/280,779, filed on Nov. 9, 2009.

(51) Int. Cl. G06F 3/048; G06F 3/041; G01S 19/42

(52) U.S. Cl. 342/357.25; 345/173; 715/702; 715/810

(57) ABSTRACT

A mobile device for displaying construction-related documents, including at least one touch-sensitive display surface, at least one image capture device, a rugged casing, and at least one handle. The device may further include a processor, a storage medium, an optical drive, a global positioning sensor, at least one power source and a plurality of external connection ports.

### RELATED APPLICATION

The present invention claims priority under 35 U.S.C. §120 to U.S. Provisional Patent Application No. 61/280,779, filed on Nov. 9, 2009, the disclosure of which is incorporated by reference herein in its entirety.

### BACKGROUND

The construction industry requires a vast amount of plans, sketches, and permits that are often revised. For many of these documents, distribution of the most current version to workers after a revision is essential to the success of the construction project. Ensuring that this distribution reliably takes place is a costly, but important process, as work may have to be repeated if not completed to the most current specifications. The sheer number of documents can make transport and use of paper copies difficult. In addition, weather and other conditions of a construction site can make the storage and display of paper copies impractical, as the copies could be damaged or destroyed. For example, in the case of construction permits, there exist various products for the display of the permits in adverse conditions, such as all-weather bulletin boards and weatherproof permit boxes.

### SUMMARY

According to at least one exemplary embodiment, a mobile device for displaying construction-related documents is disclosed. The device may include at least one touch-sensitive display surface, at least one image capture device, a rugged casing, and at least one handle. The device may further include a processor, a storage medium, an optical drive, a global positioning sensor, at least one power source and a plurality of external connection ports.

According to another exemplary embodiment, a method for displaying construction-related documents is disclosed. The method may include selecting, via a touch-screen interface, a construction-related document from a list of construction-related documents stored on a mobile device, displaying the selected construction-related document on the screen of the mobile device, editing or annotating the construction-related document, storing an updated version of the construction-related document on the mobile device, and tracking and maintaining a version history of previous versions of the construction-related document. The method may further include receiving a construction-related document from a remote device, storing the construction-related document on the mobile device, and sending the updated version of the construction-related document to the remote device.

### BRIEF DESCRIPTION OF THE FIGURES

FIG. 1a is a front view of an exemplary embodiment of a mobile device for displaying construction-related documents.

FIG. 1b is a rear view of an exemplary embodiment of a mobile device for displaying construction-related documents.

FIG. 1c is a front view of another exemplary embodiment of a mobile device for displaying construction-related documents.

FIG. 2 is an exemplary diagram showing the components of a mobile device for displaying construction-related documents.

FIG. 3a shows an exemplary interface screen for a mobile device for displaying construction-related documents.

FIG. 3b shows another exemplary interface screen for a mobile device for displaying construction-related documents.

FIG. 3c shows another exemplary interface screen for a mobile device for displaying construction-related documents.

FIG. 3d shows another exemplary interface screen for a mobile device for displaying construction-related documents.

FIG. 3e shows another exemplary interface screen for a mobile device for displaying construction-related documents.

FIG. 3f shows another exemplary interface screen for a mobile device for displaying construction-related documents.

FIG. 3g shows another exemplary interface screen for a mobile device for displaying construction-related documents.

FIG. 3h shows another exemplary interface screen for a mobile device for displaying construction-related documents.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

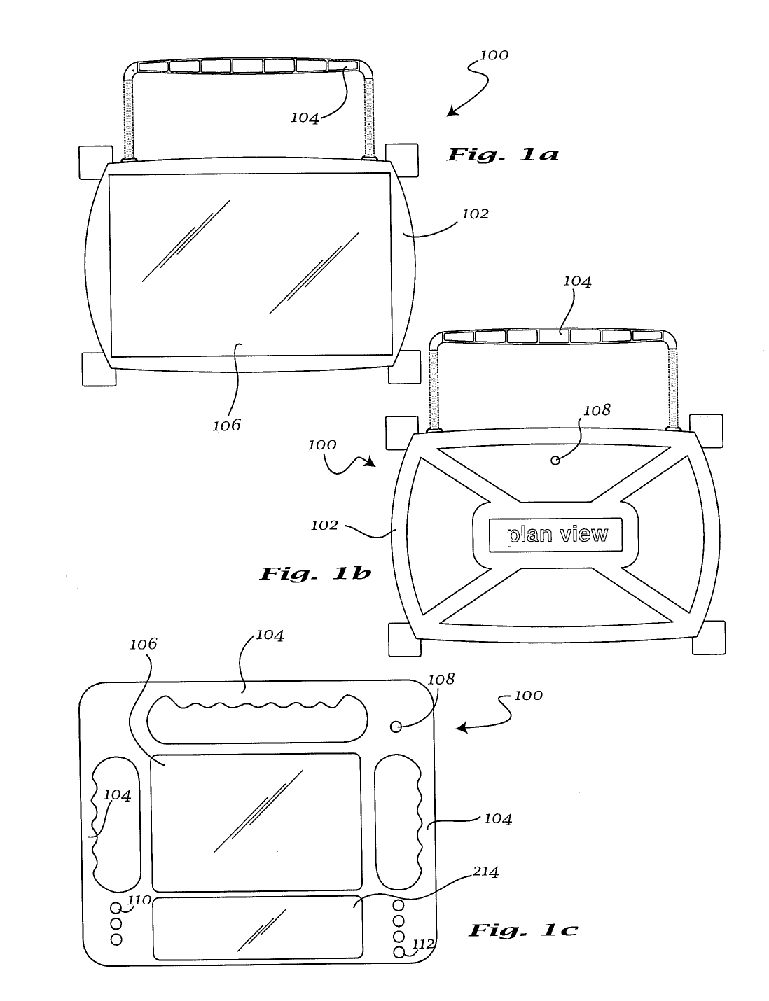

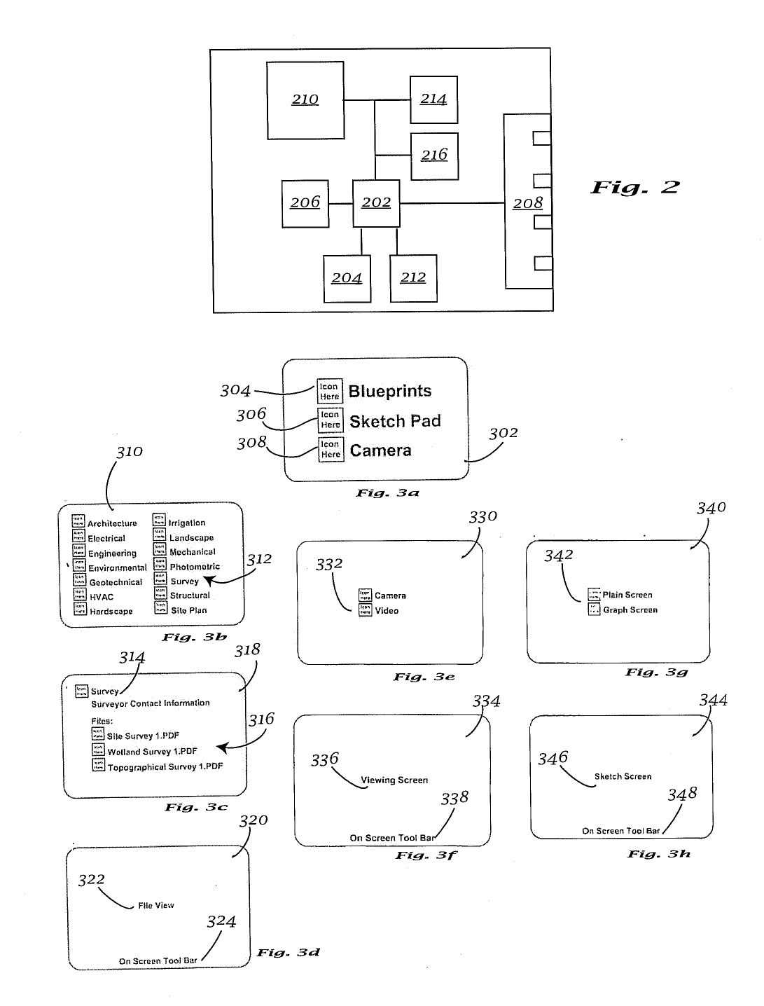

In one exemplary embodiment, as shown in FIGS. 1a-1c, a mobile device for displaying construction-related documents 100 is disclosed. Mobile device 100 may include a casing 102, at least one grip or handle 104, a display 106 and at least one image capture device 108 such as a still or video camera. In one embodiment, mobile device 102 may have a width of between about 30 inches and about 18 inches and a height of between about 24 inches and about 13 inches. Display 106 may have a width of about 17 inches and a height of about 11 inches. Handle 104 may be integrated into casing 102 and may have a generally ergonomic shape such that handle 104 allows the user to comfortably handle and transport mobile device 100. In other embodiments, handle 104 may be retractable into casing 102 and may also have a generally ergonomic shape. As shown in FIG. 2, mobile device 100 may further include a processor 202, a storage medium 204 such as a hard disk drive or solid state drive, memory 206 such as DDR2 SDRAM, a plurality of external connections 208, at least one at least one touch-sensitive surface 210 and at least one power source 212. In some embodiments, mobile device 100 may also include a touch-sensitive keyboard 214 and a touchpad 216.

Mobile device 100 may be adapted for utilization in harsh environments. Casing 102 may be formed from a lightweight, strong, material, such as, for example, a magnesium alloy, or any other material having similar properties that is known in the art. Mobile device 100 may have further adaptations for operation in harsh environments, such as vibration-resistant components, shock-resistant components, moisture resistant components, and dust-resistant components. For example, handle 104 and related mechanisms may be resistant to dust, shock and moisture. Furthermore, storage medium 204 may be resistant to vibration, dust, shock and moisture, and may be mounted within casing 102 utilizing shock-absorbing mounts or other shock-absorbing structures that are known in the art. Similarly, display 106, at least one touch-sensitive surface 210, keyboard 214 and touchpad 216 may also be resistant to vibration, dust, shock and moisture. Mobile device 100 may also be capable of operating in a wide temperature range in a wide humidity range, and at high altitudes. Mobile device 100 may further be designed to meet or surpass the MIL-STD-810F testing standards.

In some embodiments, mobile device 100 may include environmentally-friendly components, materials and energy management methods. For example, casing 102 may be fanned from recycled or otherwise environmentally-friendly materials, such as, for example, recycled stainless steel. Furthermore, certain internal components may be manufactured from materials that do not include chemical compounds that are believed to be harmful to the environment and human health. As an illustrative example, the components of mobile device 100 may be free of brominated flame retardants (BFRs). Cables associated with or included in mobile device 100 may also be free of polyvinyl chloride (PVC). Furthermore, the power management system of mobile device 100 may be designed to comply with the specifications of the Energy Star 5.0 standard. Additionally, display 106 may include arsenic-free glass.

Disposed within casing 102 may be display 106, which may be a color or monochrome liquid crystal display (LCD), an organic light-emitting diode (OLED) display, an e-ink display, or any other display known in the art that enables mobile device 100 to function as described herein. In some embodiments, display 106 may be a mercury-free display. Display 106 may be further be a touch screen display, such that the user may interact with the interface of mobile device 100 by way of the user's fingers, a stylus, or any similar methods of interaction known in the art. Display 106 may therefore act as a graphic user interface, wherein the user interface elements are adapted and sized for a touch-screen method of interaction. Display 106 may further be adapted for writing or drawing thereon, for example, by using a stylus or similar methods of writing known in the art. Display 106 may support a single resolution, or a plurality of resolutions and may be adaptable to be viewed in either a landscape or a portrait orientation. Display 106 may also be a color display and may have a luminance that enables display 106 to be viewed in direct sunlight; for example, display 106 may have a luminance of between 800 candela per square metre (800 cd/m² or 800 nit) and about 1200 candela per square metre (1200 cd/m² or 1200 nit).

Display 106 may also include an oleophobic coating, thereby facilitating the removal of fingerprint and other residue from the surface of display 106, and may also include a protector film to reduce the likelihood of imparting damage and wear and tear to display 106. Furthermore, display 106 may include a glare guard to facilitate viewing display 106 in situations where glare is present, such as, for example, outside on a clear day. Display 106 may further be associated with an ambient light sensor 110, which can facilitate adjusting the intensity of the backlighting of display 106 in relation to the amount of ambient light proximate to the display.

Power source 212 may be a lithium ion battery, a nickel metal hydride battery, or any other battery technology known in the art. Power source 212 may include thermal sensors and over-current sensors to facilitate protecting power source 212 from excesses of temperature and current. Power source 212 may further be adapted for battery charge, capacity and status reporting, and may have a battery indicator light 112 associated therewith. Power source 212 may also be recharged from an external power source, for example, via an AC adapter or a USB cable.

Mobile device 100 may further include integrated peripherals and external connections 208. A non-exhaustive and non-limiting list of such peripherals may include a wireless communications device conforming with wireless communications standards such as Bluetooth or 802.11a/b/g/n, a GPS receiver, at least one camera capable of capturing moving and still images, an optical drive, and at least one flash memory slot and interface. Wireless communications device may be adapted for communication with any wireless data network known in the art, such as, for example, GSM, CDMA, satellite, UMTS, HSDPA, and other communications networks. A non-exhaustive and non-limiting list of external connections 208 associated with mobile device 100 may include at least one Universal Serial Bus port, at least one PCMCIA slot such as PC Card or ExpressCard, at least one FireWire (IEEE 1394) port, at least one video port such as VGA, S-Video, DVI, or HDMI, at least one communications port such as Ethernet (RJ45), telephone (RJ11), or any similar ports known in the art, and at least one connector adapted for an external power source.

Mobile device 100 may be adapted to facilitate convenient viewing of construction-related documents, as well as efficient distribution of new or updated construction-related documents. To this end, mobile device 100 may include software that enables mobile device 100 to function as described herein. In one embodiment, mobile device 100 may include an operating system selected from the Microsoft Windows family of operating systems; in other embodiments, a UNIX-derived operating system may be used. Mobile device 100 may further include software that is capable of viewing and editing various file types, including AutoCAD and other known drawing, blueprint or CAD files. Other formats that may be viewed and edited via the software of mobile device 100 may include, as non-limiting examples, PDF, JPEG, DOG, DXF, TIFF, GIF, DOC, DOCS, HTML, KEY, NUMBERS, PPT, TXT, RTF, and XLS.

FIGS. 3a-3h illustrate an exemplary interface for the software of mobile device 100. It should be appreciated that the described interface features are exemplary and non-limiting. In operation, the user may be presented with a home screen 302, as shown in FIG. 3a. Home screen 302 can include a plurality of image buttons, that is, buttons displayed on the screen in graphic form, for accessing the features of mobile device 100. For example, such image buttons may include, but are not limited to, a blueprint button 304, a sketch pad button 306, and a camera button 308. In accordance with the touch-screen interface of mobile device 100, the user may “press” any image button by touching a finger, stylus, or any other pointing device directly to the image button.

FIGS. 3b-3d illustrate the screens associated with the construction-related document portion of the software. After “pressing” blueprint button 304, the user can be presented with blueprint menu 310, which may include a plurality of categories 312 under which the appropriate construction-related document files may be listed. Each of categories 312 may be displayed as an image button, thereby allowing the user to access the category simply by touching the image button on the screen. Within any category 312, the user may be presented with an information section 314 and a file list section 316. For example, when the user presses the survey button on blueprint menu 310, he or she may be presented with survey screen 318. As an illustrative example, information section 314 of survey screen 318 may include information pertaining to the surveyors for a particular project, while file list section 316 of survey screen 318 may include the survey documents pertaining to the particular project. Upon the user's selection of a particular document, by pressing the corresponding image button, the user may be presented with a file view screen 320, which may include viewing section 322 and tool bar section 324. Tool bar section 324 may present the user with controls for manipulation of the displayed document, for example, but not limited to, opening/closing the file, saving, zooming, rotating, undo/redo functions, printing, annotating, viewing next or previous screens or pages, and so forth. The user may also perform the above functions, as well as additional functions by executing “gestures” on the touch screen surface. As illustrative examples, the user may swipe a finger or a stylus leftward across the screen to display the next page, or the user may zoom into an image by placing two fingers on the screen and increasing the distance between the two fingers while maintaining them on the screen. Furthermore, in an annotation/editing mode, the user may use fingers or a stylus to write text or draw figures on the displayed file. Such annotations and edits may then be saved on mobile device 100 and associated with the particular file so that they may be redisplayed and distributed between various mobile devices 100 as desired.

FIGS. 3e-3f illustrate the screens associated with the sketch pad portion of the software. After “pressing” sketch pad button 306, the user can be presented with sketch pad menu 330, which may include a plurality of overlay choices 332 for the sketch pad mode. Each of overlay choices 332 may be displayed as an image button, thereby allowing the user to access the overlay simply by touching the image button on the screen. Such overlay choices may be a graph paper overlay, a lined paper overlay, a ruler overlay, and so forth, or a simply a plain, non-overlaid screen. Once the user presses a desired overlay choice button on sketch pad menu 330, he or she may be presented with sketch pad screen 334, which may include editing section 336 and tool bar section 338. The user's selected overlay choice may also be superimposed on editing section 336. Tool bar section 338 may present the user with controls for manipulation of the displayed document, for example, but not limited to, opening/closing the file, saving, zooming, rotating, undo/redo functions, printing, annotating, viewing next or previous screens or pages, and so forth, as well as a plurality of image editing tools. The user may also perform the above functions, as well as additional functions by executing “gestures” on the touch screen surface. As illustrative examples, the user may swipe a finger or a stylus leftward across the screen to display the next page, or the user may zoom into an image by placing two fingers on the screen and increasing the distance between the two fingers while maintaining them on the screen. Furthermore, in an annotation/editing mode, the user may use fingers or a stylus to write text or draw figures on the sketch pad screen. The resultant image or images may then be saved on mobile device 100 so that they may be redisplayed and distributed between various mobile devices 100 as desired.

FIGS. 3g-3h illustrate the screens associated with the image capture portion of the software. After “pressing” camera button 308, the user can be presented with image capture menu 340, which may include a plurality of choices 342 for the desired image capture mode. Each of image capture choices 342 may be displayed as an image button, thereby allowing the user to access a corresponding image capture mode simply by touching the image button on the screen. Such choices may be, for example, a still camera mode and a video capture mode. Once the user presses a desired choice button on image capture menu 340, he or she may be presented with image viewing screen 344, which may include viewing section 346 and tool bar section 348. Viewing section 346 may display the subject matter being viewed through camera 108 and may also display previously captured still images or video. Tool bar section 348 may present the user with controls for manipulation of the displayed document, for example, but not limited to, starting/stopping recording, taking still images, saving, zooming, rotating, undo/redo functions, printing, annotating, viewing next or previous images, and so forth, as well as a plurality of image editing tools. The user may also perform the above functions, as well as additional functions by executing “gestures” on the touch screen surface. As an illustrative example, the user may zoom into an image by placing two fingers on the screen and increasing the distance between the two fingers while maintaining them on the screen. Furthermore, in an annotation/editing mode, the user may use fingers or a stylus to write text or draw figures on the viewing screen. The resultant still images or video may then be saved on mobile device 100 so that they may be redisplayed and distributed between various mobile devices 100 as desired.

Mobile device 100 may further be adapted to facilitate real-time communications and updating of construction-related documents stored therein. For example, a project manager may distribute a desired quantity of construction-related documents to any number of users utilizing mobile devices 100. In one embodiment, distribution of such documents may be performed via a wireless network. The construction-related documents may be maintained in synchronization with a master document or with each other, such that when a project manager or a user updates a document (for example, by annotation or modification) the updated version of the document may then be distributed to all other users in a particular user group. For example, filed requests or change orders may be sent from a construction site to all consultants and construction team members, who may then make their own revisions to the plans. Mobile device 100 may thus facilitate rapid intercommunication between all project members as any user of mobile device may be able to access relevant construction-related documents regardless of whether they are located in the field or in-house. The software of mobile device 100 may also facilitate version tracking of the documents, such that past versions of each document stored on mobile device 100 may also be displayed and the changes therein highlighted. The above-described distribution of documents may be facilitated by uploading the documents to a predetermined server operating under any of the transfer protocols known in the art, for example, FTP. Upon uploading of an updated document to the server by a user of a mobile device 100, other users of mobile devices 100 may be notified regarding the updated file and the file downloaded to the mobile devices 100.

Mobile device 100 may also be adapted for real-time teleconferencing with other users of mobile devices 100. Users may utilize the video capture and video display features of mobile device 100 to facilitate video teleconferencing sessions between users. Captured video and still images may also be saved onto mobile device 100 and sent to other users, project members, managers, and so forth.

Mobile device 100 may also include location-awareness capabilities via utilization of the GPS receiver included therein. For example, mobile device 100 may utilize a GPS signal to determine its location and, consequently, display construction-related documents that are marked as being proximate or relevant to the present location of mobile device 100. Mobile device 100 may also report its location to other mobile devices 100, such that project managers and members may be aware of the geographic location and distribution of other users of mobile devices 100.

Furthermore, mobile device 100 may be adapted for use and cooperation with municipal and government agencies and consultants. For example, documents such as construction permits and any other relevant permit documentation may be electronically signed by desired municipal agents and distributed to users of mobile device 100. The need for physical on-site “permit boxes” is therefore minimized, consequently reducing the amount of paperwork and physical documents necessary to carry on a construction or other project.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A mobile device for displaying construction-related documents, comprising:
at least one touch-sensitive display surface;
at least one image capture device;
a rugged casing; and
at least one handle.

2. The mobile device of claim 1, wherein the handle is integral to the rugged casing.

3. The mobile device of claim 1, wherein the handle is retractable into the rugged casing.

4. The mobile device of claim 1, wherein the rugged casing is constructed of magnesium alloy.

5. The mobile device of claim 1, further comprising:
a processor;
a storage medium;
an optical drive;
a global positioning sensor;
at least one power source; and
a plurality of external connection ports.

6. The mobile device of claim 1, further comprising shock-, moisture-, dust- and vibration-resistant components.

7. The mobile device of claim 1, further comprising:
a touch-screen interface for viewing, editing and annotating documents.

8. The mobile device of claim 7, wherein the documents are construction-related documents.

9. The mobile device of claim 7, wherein the documents are still or moving images.

10. A method of displaying construction-related documents, comprising:
selecting, via a touch-screen interface, a construction-related document from a list of construction-related documents stored on a mobile device;
displaying the selected construction-related document on the screen of the mobile device;
editing or annotating the construction-related document;
storing an updated version of the construction-related document on the mobile device; and
tracking and maintaining a version history of previous versions of the construction-related document.

11. The method of claim 10, further comprising:
receiving a construction-related document from a remote device; and
storing the construction-related document on the mobile device.

12. The method of claim 11, further comprising:
sending the updated version of the construction-related document to the remote device.

13. The method of claim 10, further comprising:
utilizing a global positioning sensor to display construction-related documents relating to construction sites that are proximate to the location of the mobile device.
